(19) United States
(12) Patent Application Publication
(10) Pub. No.: US 2025/0020372 A1
(43) Pub. Date: Jan. 16, 2025

(54) SORPTION HEAT PUMP AND SORPTION CYCLE

(71) Applicant: AGO GmbH Energie + Anlagen, Kulmbach (DE)

(72) Inventor: Klaus Ramming, Mainleus (DE)

(21) Appl. No.: 18/759,917

(22) Filed: Jun. 30, 2024

(30) Foreign Application Priority Data
Jul. 11, 2023 (EP) EP23184670.0

(51) Int. Cl. F25B 30/04

(52) U.S. Cl. CPC F25B 30/04

(57) ABSTRACT

A sorption heat pump including a gaseous refrigerant; a liquid one-phase solution of the gaseous refrigerant in a solvent; an absorption unit in which the liquid one-phase solution absorbs a medium pressure partial flow of the refrigerant at a medium pressure level and in which the liquid one-phase solution absorbs a high pressure partial flow of the refrigerant at a high pressure level in a high pressure absorber and in which the liquid one-phase solution emits heat generated from absorbing the medium pressure partial flow and generated from absorbing the high pressure partial flow to a heat sink outside of the sorption heat pump; a generator in which the solution absorbs heat from the absorption unit at a low-pressure level from a heat source outside of the sorption heat pump and thus expels the refrigerant, a high-pressure generator in which the solution absorbs the medium pressure partial flow.

### RELATED APPLICATIONS

This application claims priority from and incorporates by reference European patent application EP 23 184 670.0 filed on Jul. 11, 2024.

### FIELD OF THE INVENTION

The invention relates to a sorption heat pump with a gaseous refrigerant and a liquid one-phase solution of the refrigerant in a solvent.

### BACKGROUND OF THE INVENTION

A generic sorption heat pump and a generic sorption cycle are known from EP 3 964 770 A1. This document proposes to initially pump a diluted solution and the refrigerant from the low pressure level to the high pressure level and feed them to the high pressure absorber and to decouple a medium pressure partial flow from the refrigerant upstream of the high pressure absorber and to expand the medium pressure partial flow to the medium pressure level so that the solvent initially only absorbs a remaining high pressure partial flow and the enriched solution thus generated absorbs the medium pressure partial flow in the medium pressure absorber.

### BRIEF SUMMARY OF THE INVENTION

Thus, it is an object of the invention to reduce energy consumption required for reaching the high-pressure level.

In heat pumps with a solvent cycle, heat emission in the absorber is performed at a sliding temperature. The mix of solvent and vaporized refrigerant initially heats up at the entry into the absorber by a large amount and then cools down again while the refrigerant is dissolved in the solvent.

The invention is based on the finding that superheating at an inlet into the absorber known in the art is not required for the phase change of the refrigerant from a gaseous condition into a liquid, dissolved condition when generating vapor since the phase change is performed at a constant temperature on the heat sink side so that the superheating limits the absorption of the refrigerant because the mix in the absorber cannot be cooled much lower than slightly above the boiling temperature of the vapor. The pressure ratio between high pressure level and low-pressure level required for driving out the refrigerant decreases with a decreasing percentage of the refrigerant and vice versa a high-pressure ratio requires a large amount of power for the compressor and a low COP of the sorption heat pump.

The object is achieved by a sorption heat pump including a gaseous refrigerant; a liquid one-phase solution of the gaseous refrigerant in a solvent; an absorption unit in which the liquid one-phase solution absorbs a medium pressure partial flow of the refrigerant at a medium pressure level and in which the liquid one-phase solution absorbs a high pressure partial flow of the refrigerant at a high pressure level in a high pressure absorber and in which the liquid one-phase solution emits heat generated from absorbing the medium pressure partial flow and generated from absorbing the high pressure partial flow to a heat sink outside of the sorption heat pump; a generator in which the solution absorbs heat from the absorption unit at a low-pressure level from a heat source outside of the sorption heat pump and thus expels the refrigerant; and a high-pressure generator in which the solution absorbs the medium pressure partial flow and emits heat generated from absorbing the medium pressure partial flow to the liquid one-phase solution at the high-pressure level so that the liquid one-phase solution at the high-pressure level expels the high-pressure partial flow of the refrigerant.

Improving upon the known sorption heat pump a high-pressure generator is proposed according to the invention in which high pressure generator the solution absorbs the medium pressure partial flow an emits heat thus generated to the solution at the high-pressure level so that the solution expels the high-pressure partial flow of the refrigerant. Differently from the prior art, this sorption heat pump according to the invention does not require a compressor to compress the high-pressure partial flow from the medium pressure level to the high-pressure level. The amount of energy thus saved is higher than the additional amount of energy required for pumping the additional mass flow of the enriched solution to the high-pressure level.

Advantageously the sorption heat pump according to the invention includes an intermediary pump that pumps the solution enriched in the high-pressure generator to the high-pressure level and feeds the latter at the high-pressure level into the high-pressure absorber. Pumping in two stages is energetically more efficient than an alternative single stage pumping and intermediary expansion from the high-pressure level to the medium pressure level.

Advantageously, a sorption heat pump according to the invention includes a medium pressure absorber, wherein the solution initially absorbs the medium pressure partial flow of the refrigerant in the high-pressure generator first, and thereafter absorbs the medium pressure partial flow of the refrigerant in the medium pressure absorber. The heat generated in the medium pressure absorber can then be additionally emitted to the heat sink.

Advantageously a reduced solution remaining from the high-pressure generator is expanded in a throttle valve to the medium pressure level and run into the medium pressure absorber. The two solutions from the high-pressure generator, the reduced solution, at the high-pressure level and the enriched solution at the medium pressure level are similar with respect to temperature and composition and can therefore be mixed without substantial losses of internal energy. Furthermore, the receiving capacity for the refrigerant in the medium pressure absorber increases with the volume flow of the solvent.

Alternatively, the reduced solution can be run into the high-pressure absorber at the high-pressure level. Then the reduced solution does not have to be expanded. The energy loss associated with the expansion is then avoided.

Advantageously a sorption heat pump according to the invention includes a sorption heat exchanger in which the solution at the medium pressure level absorbs heat from the solution at the high-pressure level. The absorbed heat is then available in the absorption unit for the heat sink.

Advantageously the medium pressure absorber, the high-pressure absorber and/or the high-pressure generator are plate heat exchangers in a sorption heat pump according to the invention. These absorbers are simple from a technical point of view, low maintenance and available economically in a plethora of embodiments.

Advantageously a sorption heat pump according to the invention includes a throttle valve that expands the solution after exiting from the sorption unit from the medium pressure to the low pressure for entry into the generator, and includes a pump and a compressor that pump the solution and the refrigerant after exiting from the generator from the low-pressure level to the medium pressure level or to the high-pressure level. A sorption heat pump of this type according to the invention absorbs heat at a low-pressure level and emits the heat at a higher-pressure level. The rich solution cools in the throttle valve and can thus absorb the low temperature heat. The gaseous refrigerant and the liquid solvent are fed to the absorption unit separately. Pumps are well known in refrigeration applications and available economically in many different variations.

Advantageously, the solvent in a sorption heat pump according to the invention is water and the refrigerant is ammonia. Water and ammonia are natural substances and well proven in refrigeration applications.

The object is also achieved by a sorption cycle with a gaseous refrigerant and a liquid one-phase solution of the refrigerant in a solvent, the sorption cycle including the liquid one-phase solution absorbing a medium pressure partial flow of the refrigerant at a medium pressure level and the liquid one-phase solution absorbing a high-pressure partial flow of the refrigerant at a high-pressure level and the liquid one-phase solution emitting heat generated from absorbing the medium pressure partial flow and generated from absorbing the high-pressure partial flow to a heat sink outside of the sorption cycle; and the liquid one-phase solution after absorbing the refrigerant absorbing heat from a heat source outside of the sorption cycle and thus expelling the refrigerant; and the liquid one-phase solution emitting heat generated by absorbing the medium pressure partial flow to the liquid one-phase solution at the high-pressure level, so that the latter expels the high-pressure partial flow of the refrigerant.

Improving upon the known sorption cycle it is proposed according to the invention is that the solution emits heat generated from absorbing the medium pressure partial flow to the solution at the high-pressure level so that the heat expels the high-pressure partial flow of the refrigerant. The sorption cycle according to the invention runs in a sorption heat pump according to the invention and is characterized by the advantages described supra.

Advantageously a heat carrier of the heat sink is divided into two partial flows run in parallel in a sorption cycle according to the invention and further advantageously heat generated from absorbing the refrigerant at the medium pressure level and at the high-pressure level is emitted to the partial flows and further advantageously the partial flows of the heat carrier are subsequently joined again. Due to very different spreads at the heat source and at the heat sink a maximum portion of the refrigerant is absorbed at the medium pressure level in the sorption cycle according to the invention and the heat thus generated is emitted to the heat carrier of the heat sink in order to generate e.g. steam at this location.

Alternatively heat generated by absorption at the medium pressure level is initially emitted to the heat carrier of the heat sink and subsequently heat generated at the high-pressure level is emitted to the heat carrier of the heat sink in the sorption cycle according to the invention. When the spread at the heat sink is much greater than at the heat source the heat carrier of the heat sink is pre-heated in the medium pressure absorber and only heated to a desired outlet temperature in the high-pressure absorber.

### BRIEF DESCRIPTION OF THE DRAWINGS

The invention is subsequently described based on advantageous embodiments with reference to drawing figures.

FIG. 1 illustrates a first embodiment sorption heat pump according to the invention;

FIG. 2 illustrates a second embodiment sorption heat pump according to the invention;

FIG. 3 illustrates a third embodiment sorption heat pump according to the invention;

FIG. 4 illustrates a fourth embodiment sorption heat pump according to the invention.

### DETAILED DESCRIPTION OF THE INVENTION

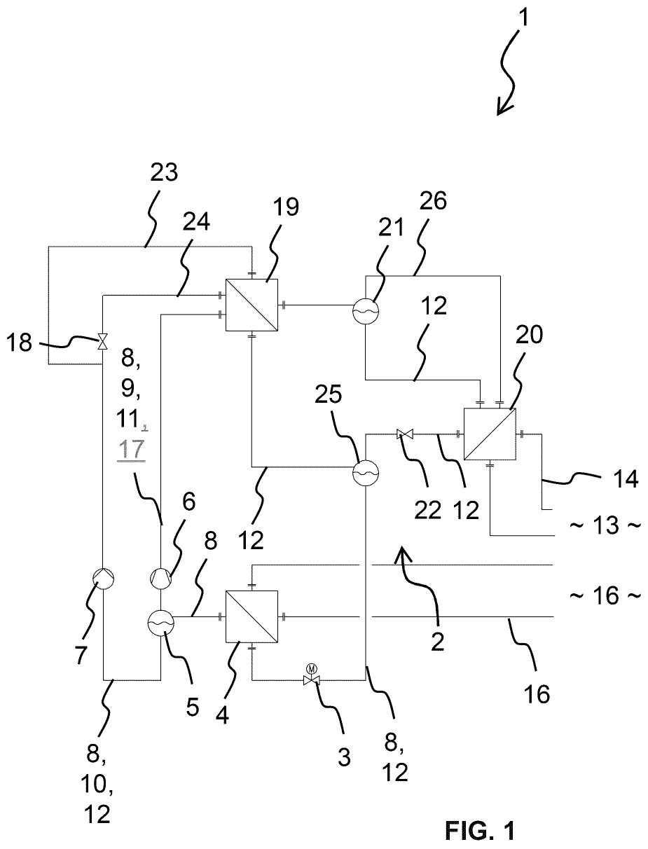

The first sorption heat pump 1 shown in FIG. 1 includes an absorption unit 2, a throttle valve 3, a generator 4, a separator 5, a compressor 6, a pump 7, and conduits 8 which connect the elements recited supra into a closed loop system, wherein the compressor 6 is arranged in a refrigerant branch 9 and the pump 7 is arranged in a solvent branch 10 running from the separator 5 to the absorption unit 2 in parallel with the refrigerant branch.

In a cycle of the sorption cycle according to the invention, ammonia (NH₃) acting as a refrigerant 11 is absorbed in a solution 12 of water acting as a solvent in the absorption unit 2 and heating power is emitted to a heat sink 13. Feed water acting as a heat carrier 14 of the heat sink 13 and entering from the heat sink 13 into the absorption unit 2 exits from the absorption unit 2 as saturated vapor. A flow of the solution 12 exiting at a high-pressure level from the absorption level 2 is expanded by the throttle 3 valve to a low-pressure level and heated in the generator 4 by a heat source 16, wherein the heat carrier 17 of the heat source 16 is cooled. From the subsequent separator 5 the remaining solution 12 is pumped in the solvent branch 10 by the pump 7 to the high-pressure level and a medium pressure partial flow 17 of the refrigerant 11 is pumped in the refrigerant branch 9 to a medium pressure level by the compressor 6 and fed into the absorption unit 2.

The absorption unit 2 includes a throttle valve 18, a high-pressure generator 19, a high-pressure absorber 20, a high-pressure separator 21, and an additional throttle valve 22.

The solution 12 is initially divided into a high-pressure partial flow 23 and a medium pressure partial flow 24. The medium pressure partial flow is expanded to the medium pressure level in the throttle valve 18 and run into the high-pressure generator 19 and absorbs the refrigerant 11 in the high-pressure generator 19. The enriched solution 12 exiting from the high-pressure generator 19 is run through a solution collector 25 into the generator 4.

The high-pressure partial flow 23 of the solution 12 absorbs heat released in the high-pressure generator 19 and separates a high-pressure partial flow of the refrigerant in the high-pressure separator 21. The remaining reduced solution 12 absorbs the high-pressure partial flow 26 in the high-pressure absorber 20 and emits the released heat to the heat carrier 14 of the heat sink 13. The solution 12 exiting from the high-pressure absorber 20 is expanded to the medium pressure level in another throttle valve 22 and is also run into the solution collector 25.

The generator 4, the high-pressure absorber 20 and the high-pressure generator 19 are plate heat exchangers.

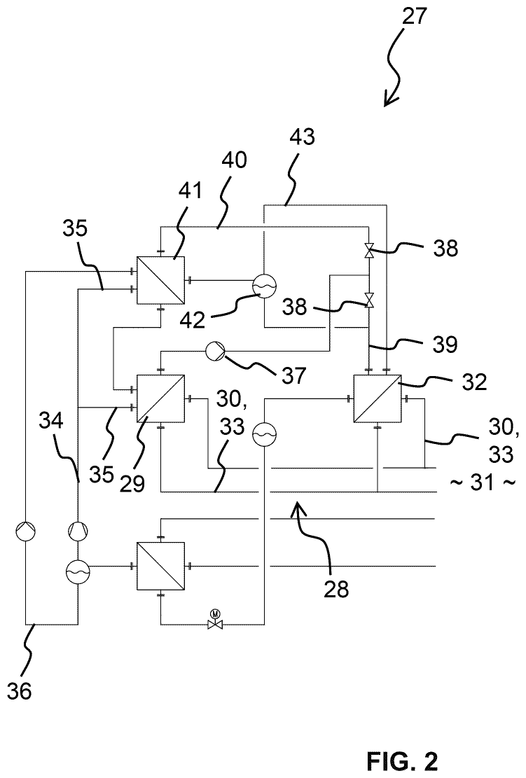

The second sorption heat pump 27 according to the invention illustrated in FIG. 2 essentially corresponds to the first sorption heat pump 1. As a difference the absorption unit 28 of the second sorption heat pump 27 includes a medium pressure absorber 29. Before entering the medium pressure absorber 29 and the high-pressure absorber 32, the heat carrier 30 of the heat sink 31 is initially divided into two partial flows 33, the medium pressure absorber 29 and the high-pressure absorber 32 are flowed through by the partial flows 33 which absorb heat generated in the medium pressure absorber 29 and the high-pressure absorber 32 and are joined again after exiting the medium pressure absorber 29 and high-pressure absorber 32. When entering the absorption unit 28 at the medium pressure level, the medium pressure flow 34 of the refrigerant is also initially divided into two partial flows 35 which run in parallel into the high-pressure generator 18 and the medium pressure absorber 29 and which are subsequently absorbed by the solution 36 in the high-pressure generator 18 and in the medium pressure absorber 29.

The absorption unit 28 further includes an intermediary pump 37 and two control valves 38. The solution 36 exiting the medium absorber 29 is initially pumped to a high-pressure level by the intermediary pump 37 and then separated. A first partial flow 39 flows through the control valves 38 into the high-pressure absorber 32. A second partial flow 40 flows into the high-pressure generator 41, receives heat in the high-pressure generator 41 and separates a high-pressure partial flow 43 of the refrigerant 11 in the high-pressure separator 42, thereafter the high-pressure partial flow 43 is run into the high-pressure absorber 32 and separated therein. The reduced solution 36 remaining from the high-pressure separator 42, is run into the high-pressure absorber 32 with the first partial flow 39 of the solution 36.

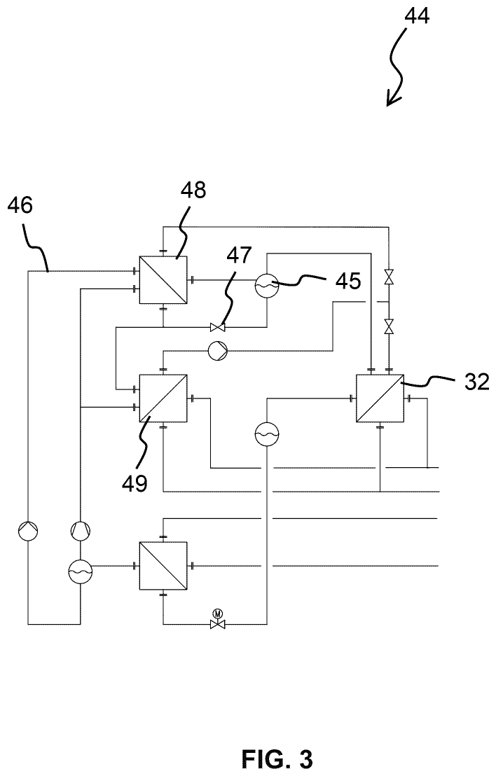

The third sorption heat pump 44 illustrated in FIG. 3 essentially corresponds to the second sorption heat pump 27. Differently, however, the third sorption heat pump 44 expands the diluted solution 46 remaining in the high-pressure separator 45 to the medium pressure level in a throttle valve 47 and runs the diluted solution 46 into the medium pressure absorber together with the enriched solution exiting from the high-pressure generator 48.

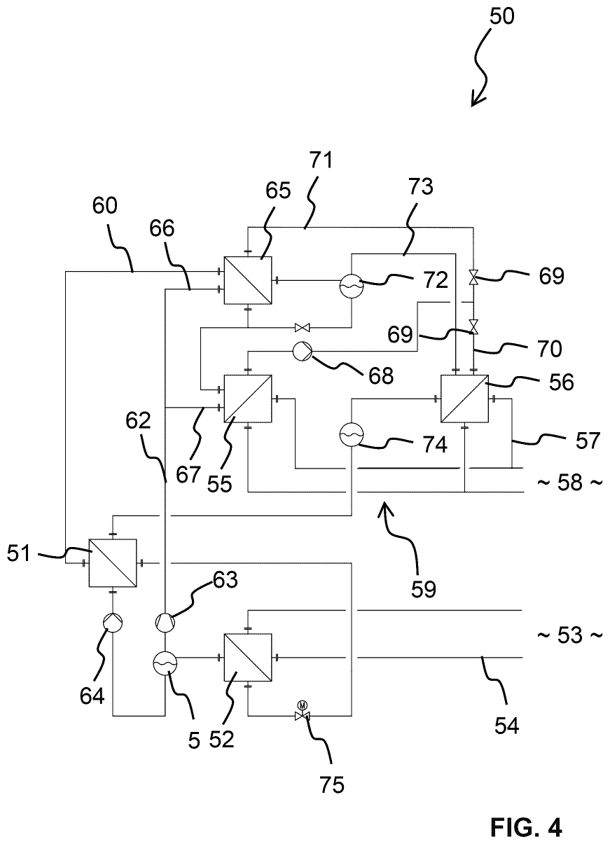

The fourth sorption heat pump 50 according to the invention illustrated in FIG. 4 and the sorption cycle according to the invention running therein essentially correspond to the third sorption heat pump 1. Additionally, the fourth sorption heat pump 50 includes a solution heat exchanger 51 between the medium pressure level and the high-pressure level.

When the fourth sorption heat pump 50 operates, the generator 52 absorbs a power of 825 KW, from the heat source 53. A flow of 13.1 kg/s of the heat carrier 54 of the heat source 53 flows in at 100 degrees C. and flows out at 85 degrees C. The medium pressure absorber 55 has a power of 678 kW and the high-pressure absorber 56 has a power of 322 kW. A flow of 0.437 kg/s of the heat carrier 57 of the heat sink 58 flows into the absorption unit 59 at 100 degrees C. and flows out at 120 degrees C. at 2 bar.

2.94 kg/s of the rich solution 60 with 65.5% refrigerant flow at a low-pressure level of 23 bar at 82 degrees C. into the generator 52 and separates a medium pressure partial flow 62 of 0.91 kg/s of 98% pure gaseous refrigerant at 97 degrees C. in the separator 61 wherein the gaseous refrigerant is compressed to a medium pressure level of 54 bar by the compressor 63, and run into the absorption unit 59 at 186 degrees C. The remaining flow of 2.03 kg/s solution 60 with a remainder of 51% ammonia is also pumped to the medium pressure level by the pump 64, absorbs 241 KW heat in the solution heat exchanger 51 from the rich solution 60 and flows into the absorption unit 59 at 121 degrees C.

The solution 60 absorbs the first partial flow 66 of 0.49 kg/s of the refrigerant 11 in the high-pressure generator 65 at 139 degrees C. and exits the high-pressure generator in 2.52 kg/s of the enriched solution 60 with 60% ammonia at 125 degrees C., is run together with 2.26 kg/s of the reduced enrichment solution 60 with 56% ammonia at 136 degrees C. and mixed with 58% ammonia at 131 degrees C. and run into the medium pressure absorber 55, and absorbs the second partial flow 67 of 0.42 kg/s of the refrigerant 11 and exits the medium pressure absorber 55 in a flow of 5.2 kg/s with 61.5% ammonia at 123 degrees C.

The enriched solution 60 is pumped by the intermediary pump 68 to the high-pressure level of 56 bar at 123 degrees C. and divided into two partial flows 70, 71 of the 2.6 kg/s respectively by the control valves 69. The second partial flow 71 of the enriched solution 60 is heated to 136 degrees C. in the high-pressure generator 65 and expels the high-pressure partial flow 73 of 0.34 kg/s of the 96% pure refrigerant 11 in the high-pressure separator 72. The first partial flow 70 of the enriched solution 60 absorbs the high-pressure partial flow 73 of the refrigerant in the high-pressure absorber 56. The rich solution 60 exits the solution collector 74 at 123 degrees C., flows through the solution heat exchanger 51 and is throttled to the low-pressure level in the throttle valve 65.

### REFERENCE NUMERALS AND DESIGNATIONS

1 sorption heat pump
2 absorption unit
3 throttle valve
4 generator
5 separator
6 compressor
7 pump
8 conduit
9 refrigerant branch
10 solvent branch
11 refrigerant
12 solution
13 heat sink
14 heat carrier of the heat sink
15 heat source
16 hear carrier of heat source
17 medium pressure partial flow of refrigerant
18 throttle valve
19 high-pressure generator
20 high-pressure absorber
21 high-pressure separator
22 throttle valve
23 high-pressure partial flow of solution
24 medium pressure partial flow of solution
25 solution collector
26 high-pressure partial flow of refrigerant
27 sorption heat pump
28 absorption unit
29 medium pressure absorber
30 heat carrier of heat sink
31 heat sink
32 high-pressure absorber
33 partial flow of heat carrier
34 medium pressure partial flow
35 partial flow of refrigerant
36 solution
37 intermediary pump
38 control valve
39 partial flow of solution
40 partial flow of solution
41 high-pressure generator
42 high pressure separator
43 high-pressure partial flow of refrigerant
44 sorption heat pump
45 high-pressure separator
46 solution
47 throttle valve
48 high pressure generator
49 medium pressure absorber
50 sorption heat pump
51 solution heat exchanger
52 generator
53 heat source
54 heat carrier of heat source
55 medium pressure absorber
56 high-pressure absorber
57 heat carrier of heat sink
58 heat sink
59 absorption unit
60 solution
61 separator
62 medium pressure partial flow of refrigerant
63 compressor
64 pump
65 high-pressure generator
66 partial flow of refrigerant
67 partial flow of refrigerant
68 intermediary pump
69 control valve
70 partial flow of solution
71 partial flow of solution
72 high-pressure separator
73 high-pressure partial flow of refrigerant
74 solution collector
75 throttle valve

1. A sorption heat pump, comprising:
a gaseous refrigerant;
a liquid one-phase solution of the gaseous refrigerant in a solvent;
an absorption unit in which the liquid one-phase solution absorbs a medium pressure partial flow of the refrigerant at a medium pressure level and in which the liquid one-phase solution absorbs a high pressure partial flow of the refrigerant at a high pressure level in a high pressure absorber and in which the liquid one-phase solution emits heat generated from absorbing the medium pressure partial flow and generated from absorbing the high pressure partial flow to a heat sink outside of the sorption heat pump;
a generator in which the solution absorbs heat from the absorption unit at a low-pressure level from a heat source outside of the sorption heat pump and thus expels the refrigerant; and
a high-pressure generator in which the solution absorbs the medium pressure partial flow and emits heat generated from absorbing the medium pressure partial flow to the liquid one-phase solution at the high-pressure level so that the liquid one-phase solution at the high-pressure level expels the high-pressure partial flow of the refrigerant.

2. The sorption heat pump according to the preceding claim 1, further comprising: an intermediary pump that pumps the liquid one-phase solution enriched in the high-pressure generator to the high-pressure level and feeds the latter at the high-pressure level into the high-pressure absorber.

3. The sorption heat pump according to claim 2, further comprising: a medium pressure absorber, wherein the liquid one phase solution absorbs the medium-pressure partial flow of the refrigerant in the high-pressure generator first, and thereafter in the medium pressure absorber.

4. The sorption heat pump according to claim 3, wherein a reduced solution remaining from the high-pressure generator is expanded in a throttle valve to the medium pressure level and run into the medium pressure absorber.

5. The sorption heat pump according to claim 1, further comprising a solution heat exchanger in which the liquid one phase solution at the medium pressure level absorbs heat from the liquid one phase solution at the high-pressure level.

6. The sorption heat pump according to claim 1, wherein the high-pressure generator, the medium pressure absorber and/or the high-pressure absorber are plate heat exchangers.

7. The sorption heat pump according to claim 1, further comprising:
a throttle valve that expands the liquid one-phase solution after exiting the absorption unit from the high-pressure level to the low-pressure level to enter the generator; and
a pump and a compressor that pump the solution and the refrigerant after exiting from the generator from the low-pressure level to the medium pressure level or to the high-pressure level.

8. The sorption heat pump according to claim 1, wherein the solvent is water and the refrigerant is ammonia.

9. A sorption cycle with a gaseous refrigerant and a liquid one-phase solution of the refrigerant in a solvent, the sorption cycle comprising:
the liquid one-phase solution absorbing a medium pressure partial flow of the refrigerant at a medium pressure level and the liquid one-phase solution absorbing a high-pressure partial flow of the refrigerant at a high-pressure level and the liquid one-phase solution emitting heat generated from absorbing the medium pressure partial flow and generated from absorbing the high-pressure partial flow to a heat sink outside of the sorption cycle; and
the liquid one-phase solution after absorbing the refrigerant absorbing heat from a heat source outside of the sorption cycle and thus expelling the refrigerant; and
the liquid one-phase solution emitting heat generated by absorbing the medium pressure partial flow to the liquid one-phase solution at the high-pressure level, so that the latter expels the high-pressure partial flow of the refrigerant.

10. The sorption cycle according to claim 9, wherein a heat carrier of the heat sink is divided into two partial flows run in parallel and wherein heat generated from absorbing the refrigerant at the medium pressure level and at the high-pressure level is emitted to the two partial flows and wherein the two partial flows of the heat carrier are subsequently joined again.
